(19) United States
(12) Patent Application Publication
(10) Pub. No.: US 2015/0056827 A1
(43) Pub. Date: Feb. 26, 2015

(54) HIGH SPEED MODULAR JACK HAVING TWO STACKED PRINTED CIRCUIT BOARDS

(71) Applicant: HON HAI PRECISION INDUSTRY CO., LTD., New Taipei (TW)

(72) Inventors: SHENG-PIN GAO, Kunshan (CN); CHIH-CHING HSU, New Taipei (TW); DAO-KUAN ZHANG, Kunshan (CN)

(21) Appl. No.: 14/468,293

(22) Filed: Aug. 25, 2014

(30) Foreign Application Priority Data
Aug. 23, 2013 (CN) 2013205160116

(51) Int. Cl. H01R 12/71; H01R 13/6581

(52) U.S. Cl. CPC H01R 12/71; H01R 13/6581
USPC 439/78

(57) ABSTRACT

A modular jack includes an insulative housing, a lower PCB (printed circuit board), an upper PCB, a set of lower contacts mounted on the lower PCB, a set of upper contacts mounted on the upper PCB, and a terminal module located below the lower PCB. The terminal module has a set first terminals electrically connected to the upper contacts through the upper PCB, a set of second terminals electrically connected to the lower contacts through the lower PCB, and a metal shielding plate disposed between the first and second terminals. The lower PCB has a first edge with a lower cutout recessed therefrom and the upper PCB has a second edge with an upper cutout recessed therefrom. The metal shielding plate has a top inserting section inserted in the lower and upper cutouts and soldered to the upper and lower PCBs only in one soldering process.

### BACKGROUND OF THE INVENTION

1. Field of the Invention

The present invention relates to a modular jack suitable for high-speed communication, and more particularly to a RJ45 receptacle connector having two stacked printed circuit boards (PCBs).

2. Description of Related Art

U.S. Patent Application Publication No. 2012/0196479, published on Aug. 2, 2012, discloses a modular jack used for 10 Gbps Ethernet. The modular jack includes an insulative housing with a mounting port and a row of insert modules inserted into the mounting port along a back-to-front direction. Each insert module has a left vertical PCB, a right vertical PCB, and a central shielding ground plate sandwiched between the vertical PCBs for shielding EMI (electromagnetic interference). The central shielding ground plate has a left arm and a right arm for soldering to vertical PCBs. The central shielding ground plate needs to be soldered separately with the two vertical PCBs.

Hence, a modular jack having a simple structure for soldering two PCBs is desired.

### SUMMARY OF THE INVENTION

Accordingly, an object of the present invention is to provide a modular jack having a simple structure for soldering two PCBs.

In order to achieve the object set forth, the invention provides a modular jack comprising an insulative housing, a lower PCB, an upper PCB stacked on the lower PCB, a set of lower contacts, a set of upper contacts and a terminal module located below the lower PCB. The insulative housing defines a lower port, an upper port stacked on the lower port, and a mounting port located behind the lower and upper ports. The lower PCB is disposed horizontally in the mounting port and has a bottom face facing downwardly. The upper PCB is stacked on the lower PCB and has a top face facing upwardly. Each lower contact has a lower contacting portion extending backwardly and downwardly in the lower port and a connecting portion mounted on the bottom face. Each upper contact has an upper contacting portion extending backwardly and upwardly in the upper port and an upper connecting portion mounted on the top face of the upper PCB. The terminal module has a set first terminals electrically connected to the upper contacts through the upper PCB, a set of second terminals electrically connected to the lower contacts through the lower PCB, and a metal shielding plate disposed between the first terminals and the second terminals. The lower PCB has a first edge with a lower cutout recessed therefrom and the upper PCB also has a second edge with an upper cutout recessed therefrom. The metal shielding plate has a top inserting section inserted in the lower and upper cutouts and simultaneously soldered to the upper PCB and lower PCB.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a modular jack according to the present invention, mounted on a horizontal mother printed circuit board (PCB);

FIG. 2 is an exploded view of the modular jack shown in FIG. 1;

FIG. 3 is a perspective view of the modular jack shown in FIG. 1, with a shielding shell being removed;

FIG. 4 is a perspective view of an insert module shown in FIG. 1;

FIG. 5 is another perspective view of the insert module shown in FIG. 4;

FIG. 6 is an exploded view of the insert module shown in FIG. 4;

FIG. 7 is another exploded view of the insert module shown in FIG. 6;

FIG. 8 is a perspective view of two adjacent insert modules and a central shield positioned therebeween; and

FIG. 9 is a part cross-sectional view of the modular jack, taken along line 9-9 of FIG. 1.

### DETAILED DESCRIPTION OF THE PREFERRED EMBODIMENT

Reference will now be made in detail to the preferred embodiment of the present invention.

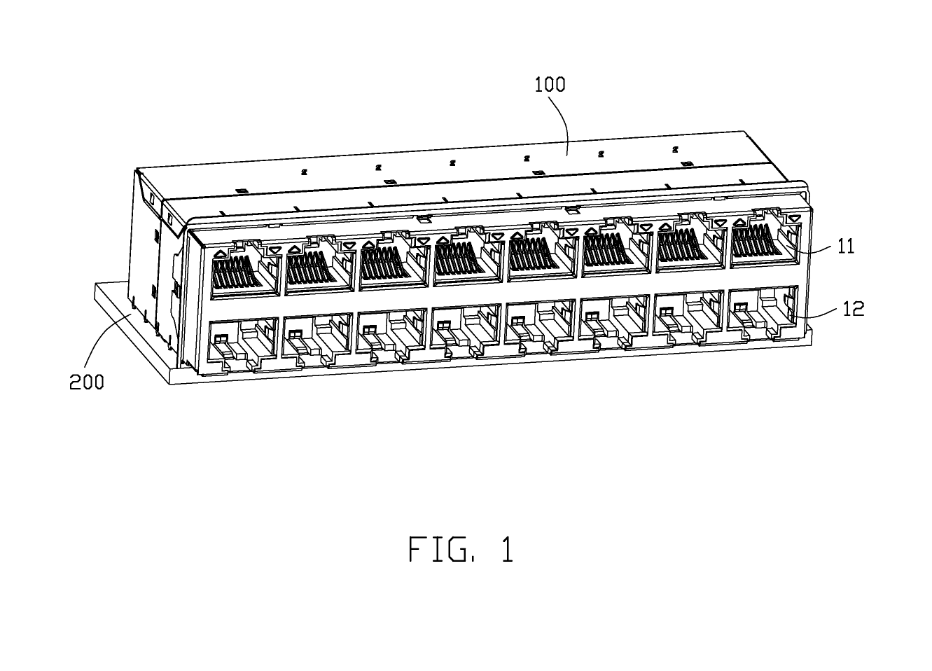

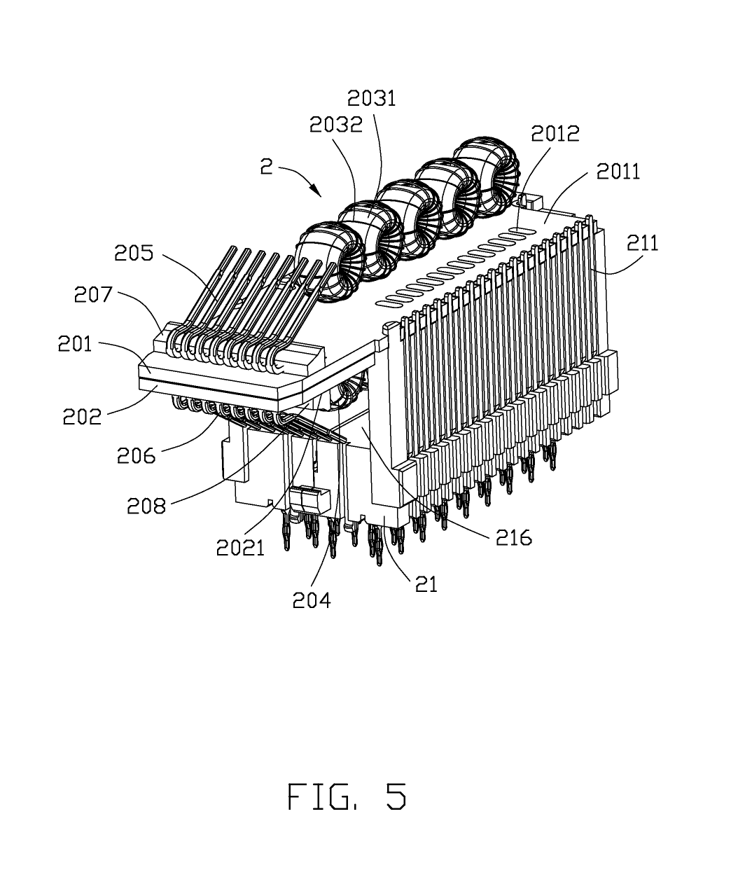

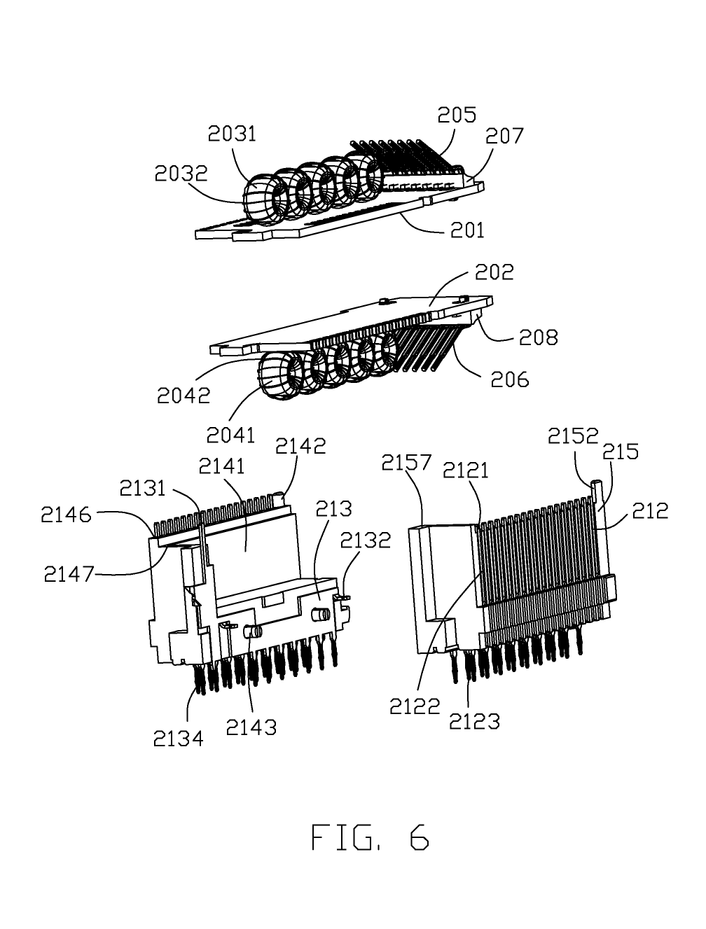

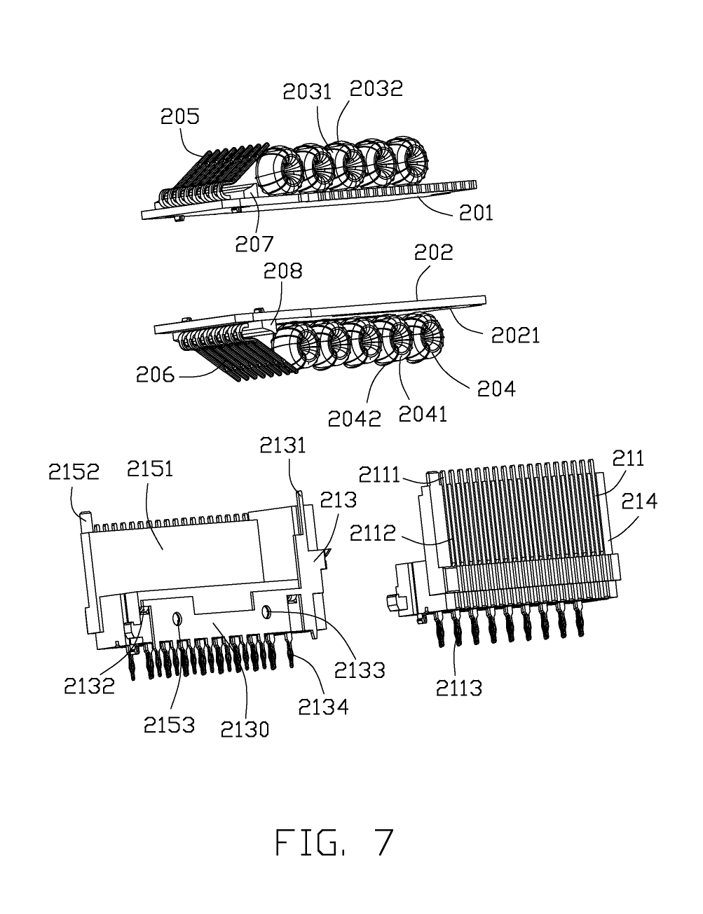

Referring to FIGS. 1-9, a 2×N-port modular jack 100 according to the present invention is shown. The modular jack 100 could be mounted on a horizontal mother PCB 200.

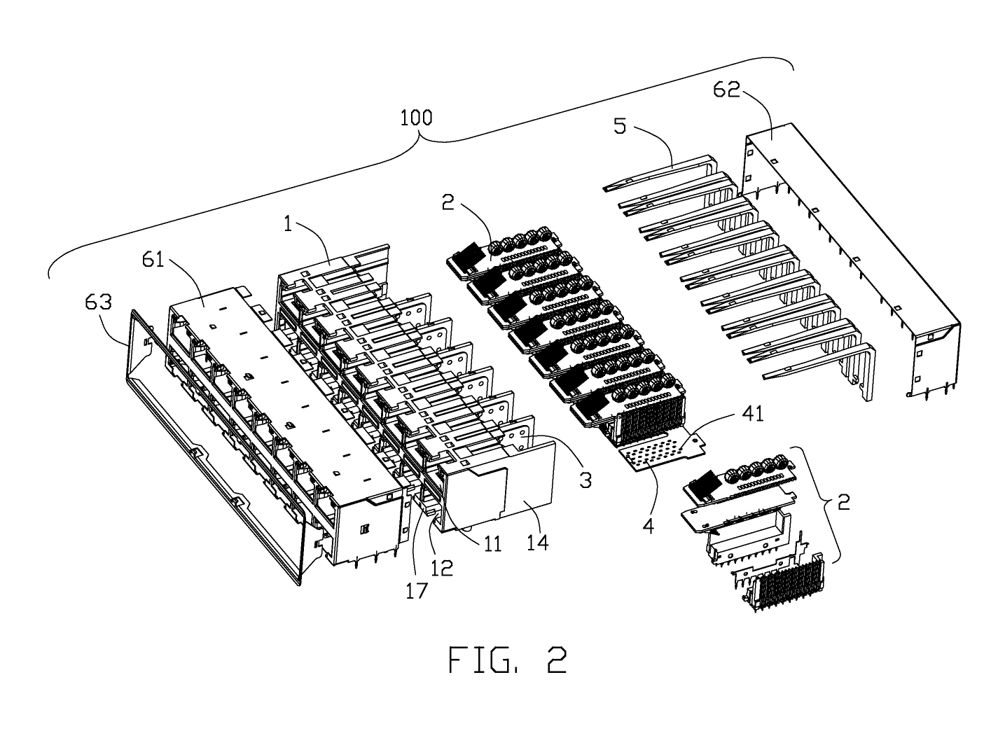

Referring to FIG. 2, the modular jack 100 includes an insulative housing 1, a plurality of insert modules 2 assembled to the insulative housing 1 along a back-to-front direction, a plurality of central shields 3 each disposed between two adjacent insert modules 2, a bottom PCB 4 mounted onto the insert modules 2 along a bottom-to-top direction, a plurality of light pipes 5 mounted to the insulative housing 1 along the back-to-front direction, and a shielding shell assembly enclosing the insulative housing 1. The shielding shell assembly includes a front metal shell 61, a rear metal shell 62 assembled with the front metal shell 61, and a metal frame 63 mounted to a front portion of the front metal shell 61.

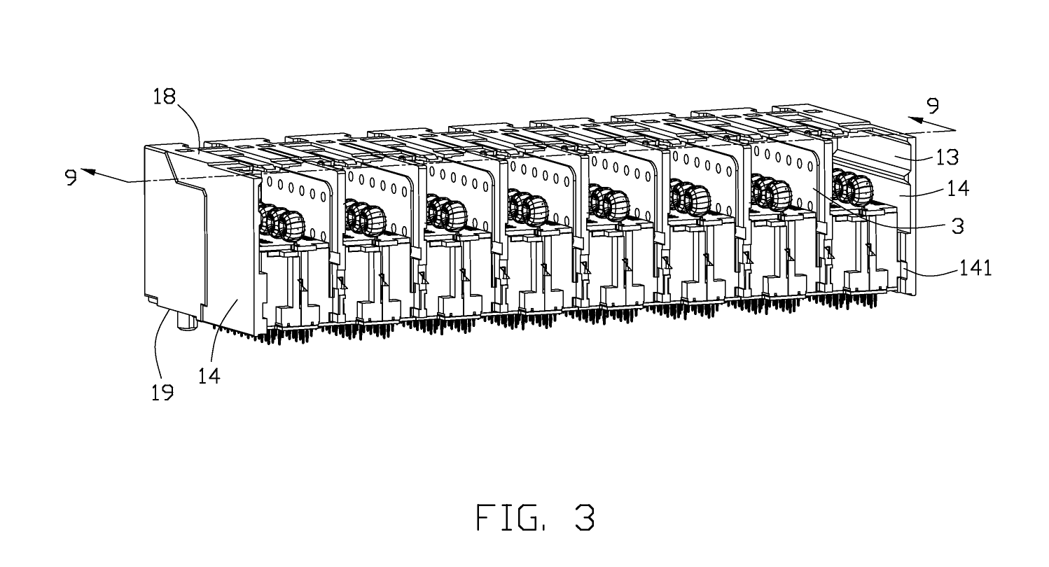

Referring to FIGS. 2-3, the insulative housing 1 defines a row of lower ports 12 and a row of upper ports 11 vertically stacked in columns, each of which is used to receive a modular plug (not shown) with a high speed, e.g., 10 Gigabit/second. The insulative housing 1 also defines a mounting port 13 located behind the upper and lower ports 11, 12. Each insert module 2 is inserted from the mounting port 13 into corresponding one lower port 12 and one upper port 11. The insulative housing 1 includes a front wall 17, a top wall 18, a lower wall 19, and two side walls 14. The upper and lower ports 11, 12 are recessed from the front wall 17 along a front-to-back direction. The lower wall 19 is used for mounting onto the horizontal mother PCB 200.

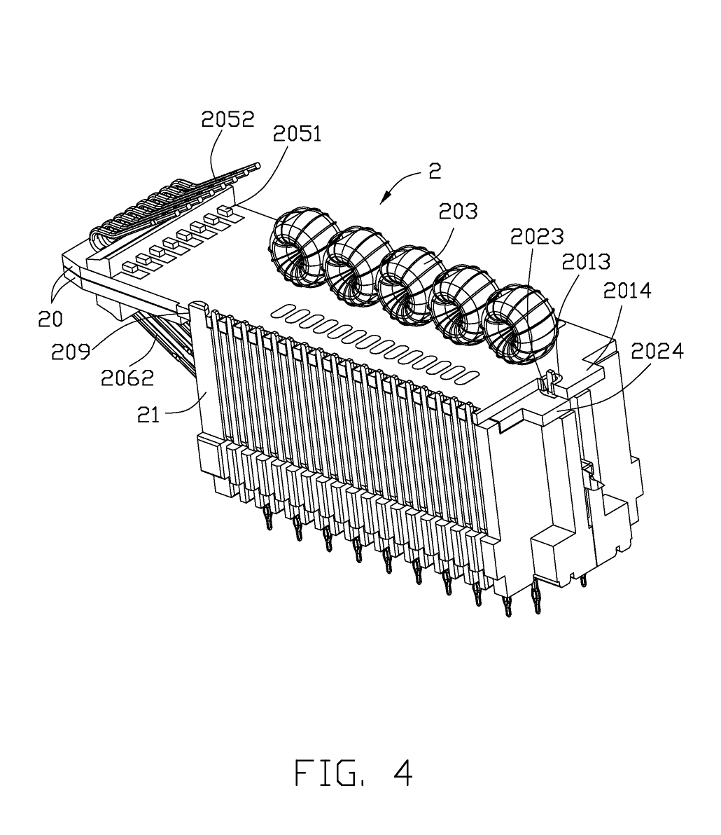

Referring to FIGS. 4-7, each insert module 2 includes a horizontal PCBA (printed circuit board assembly) 20 and a terminal module 21 located below the horizontal PCBA 20. The PCBA 20 includes a top face 2011, a bottom face 2021, and a plurality of isolation transformers 203, 204 mounted thereon. The PCBA includes a lower PCB 202 and an upper PCB 201 stacked thereon. The upper PCB 201 includes the top face 2011 with two rows of conductive pads 2012 exposed thereon. Similarly, the lower PCB 202 includes a bottom face 2021 with two rows of conductive pads (not shown) exposed thereon. The isolation transformers 203, 204 include a set of upper transformers 203 mounted on the top face 2011 and a set of lower transformers 204 mounted on the bottom face 2021. Each upper transformer 203 includes a torrid core 2031 disposed between the two rows of conductive pads 2012 and a plurality of coils 2032 winding around the torrid core 2031. Similarly, each lower transformer 204 includes a torrid core 2041 disposed between the two rows of conductive pads of the lower PCB 202 and a plurality of coils 2042 winding around the torrid core 2041. The ends of the coils 2032, 2042 are soldered to corresponding conductive pads 2012 through an automatic soldering machine. Each of the upper and lower PCBs 201, 202 also has a plurality of common mode chokes (not shown), capacitors (not shown), and resistances (not shown) mounted thereon. Each transformer 203, 204 electrically connects corresponding common mode choke through traces of the PCBA 20. The capacitors and resistances are used for forming a Bob-Smith circuit. The isolation transformers 203, 204 are mounted on the upper and bottom faces 2011, 2021 of the PCBA 20 that the isolation transformers 203, 204 could be automatically soldered to the PCBA 20. The room of the PCBA 20 is full utilized through two opposite faces of the PCBA 20 mounted with the isolation transformer 203, 204. The PCBA 20 also could be replaced by one multi-layer PCB, however the cost of the multi-layer PCB would be high. If the isolation transformers 203, 204 soldered on two opposite faces of the multi-layer PCB, it is complex for turning the multi-layer PCB over for soldering.

The PCBA 20 includes an upper plastic body 207, a set of upper contacts 205 insert molded with the upper plastic body 207, a lower plastic body 208, and a set of lower contacts 206 insert molded with the lower plastic body 208. The upper plastic body 207 is mounted on the top face 2011 and each upper contact 205 is soldered on the top face 2011. The lower plastic body 208 is mounted on the bottom face 2021 and each lower contact 206 is soldered on the bottom face 2021. Each upper contact 205 has an upper contacting portion 2052 extending backwardly and upwardly in the upper port 11 and a connecting portion 2051 surface mounted on a front portion of the top face 2011. Each lower contact 206 has a lower contacting portion 2062 extending backwardly and downwardly in the lower port 12 and a connecting portion (not labeled) surface mounted on a front portion of the bottom face 2021.

Referring to FIG. 4, the upper PCB 201 has an upper rear tail 2014 with a left edge and an upper cut 2013 recessed therefrom along a left-to-right direction. The lower PCB 202 has a lower rear tail 2024 with a right edge and a lower cut 2023 recessed therefrom along a right-to-left direction. The upper and lower tails 2014, 2024 are shifted in the bottom-to-top direction. The upper rear tail 2014 protrudes from a rear portion of the upper PCB 201 along a front-to-back direction. The lower tail 2024 protrudes from a rear portion of the lower PCB 202 along the front-to-back direction. The upper cut 2013 is disposed at least partially overlapped with the lower cut 2023 in the vertical direction. The upper cut 2013 and the lower cut 2023 are conductive vias for electrically connecting with ground layers of upper PCB 201 and the lower PCB 202 respectively.

The terminal module 21 includes a set of first terminals 211 connected with the upper PCB 201, a set of second terminals 212 connected with the lower PCB 202, and a metal shielding plate 213 disposed between the first and second terminals 211, 212. The upper contacts 205 electrically connect with corresponding first terminals 211 through the upper PCB 201 and the upper transformers 203. The lower contacts 206 electrically connect with corresponding second terminals 212 through the lower PCB 202 and the lower transformers 204. The metal shielding plate 213 is used for shielding electromagnetic interference (EMI) between the first and second terminals when they transmitting signals. The terminal module 21 has a first insulative carrier 214 for retention of the first terminals 211 and a second insulative carrier 215 for retention of the second terminals 212. The metal shielding plate 213 is sandwiched between the first and second insulative carriers 214, 215. There is a receiving chamber 216 defined by the first insulative carrier 214 and the second insulative carrier 215. The lower transformers 204 mounted on the lower PCB 202 are received in the receiving chamber 216. The first insulative carrier 214 has a first receiving chamber 2141 and the second insulative carrier 215 has a second receiving chamber 2151. The first receiving chamber 2141 and the second receiving chamber 2151 assembled to form the receiving chamber 216. The first insulative carrier 214 has a first post 2142 mounting into a through hole 209 of the upper PCB 201. The second insulative carrier 215 has a second post 2152 mounting a through hole (not labeled) of the lower PCB 202. The first insulative carrier 214 has a positioning post 2143 and the second insulative carrier 215 has a positioning hole 2153 for the positioning post 2143 inserting therein. Each first terminal 211 includes a first connecting portion 2111 connecting with the upper PCB 201, a first holding portion 2112 held by the first insulative carrier 214, and a first mounting portion 2113 located below the bottom PCB 4. The second terminal 212 includes a second connecting portion 2121 connecting with the lower PCB 201, a second holding portion 2122 held by the second insulative carrier 215, and a second mounting portion 2123 located below the bottom PCB 4. The first mounting portion 2113 and the second mounting portion 2123 are used for electrically and mechanically engagement with the horizontal mother PCB 200. The first insulative carrier 214 has a first supporting face 2146 and a second supporting face 2147 located below the first supporting face 2146. The second carrier 215 having a third supporting face 2157 disposed at a same level with the second supporting face 2147. The upper PCB 201 is supported by the first supporting face 2146 and the lower PCB 202. The lower PCB 202 is supported by the second face 2147 and the third supporting face 2157.

The metal shielding plate 213 has a main body portion 2130, a top inserting section 2131 extending upwardly from the main body portion 2130, and a mounting portion 2134 extending downwardly from the main body portion 2130. The main body portion 2130 defines two holes 20133 for the positioning post 2143 passing over. The mounting portions 2134 are used for electrically and mechanically engagement with the horizontal mother board 200. The top inserting section 2131 is inserted into the first cutout 2013 and the second cutout 2023. The top inserting section 2131 is simultaneously soldered to the upper PCB 201 and the lower PCB 202.

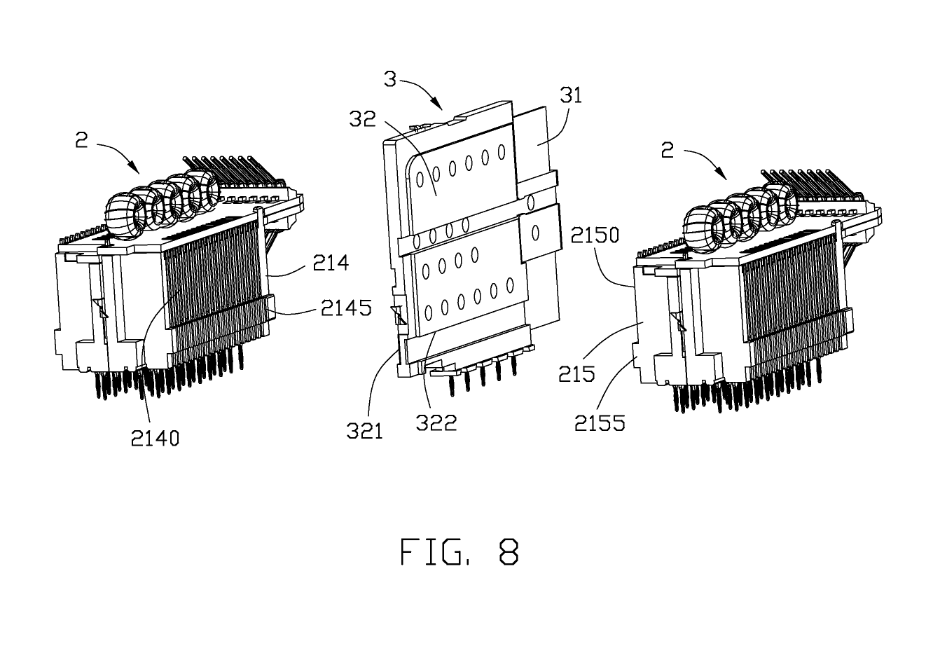

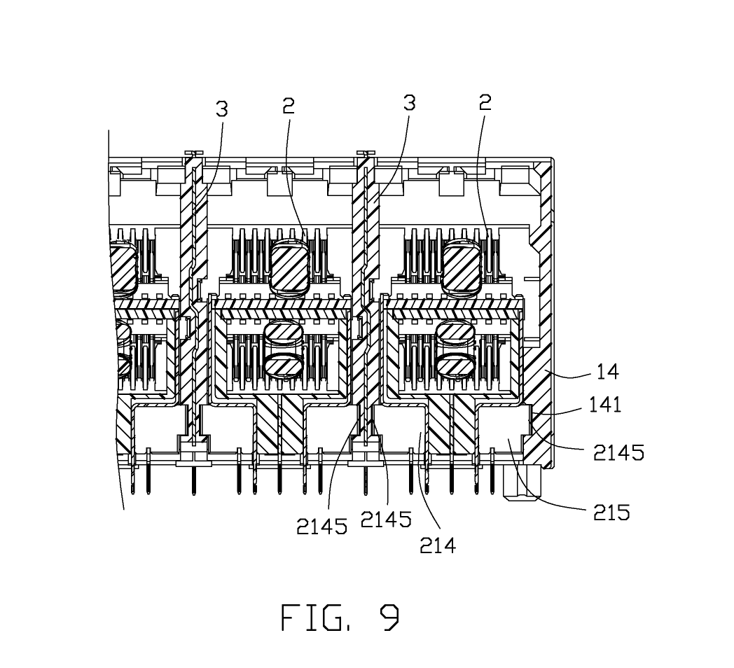

Referring to FIGS. 8-9, the insert module 2 is disposed between two adjacent central shields 3 or between one central shield 3 and one side wall 14 of the insulative housing 1. The central shield 3 includes an insulative body 32 and a metal wafer 31 insert molded with the insulative body 32. The first insulative carrier 214 has two side wall 2140 each having a first pressing protrusion 2145 protruded therefrom and extending the front-to-back direction. The second insulative carrier 215 has two side wall 2150 each having a second pressing protrusion 2155 protruded therefrom and extending the front-to-back direction. The insulative body 32 defines a left slot 321 and a right slot 322. The first pressing protrusion 2145 and the second pressing protrusion 2155 are received in the left slot 321 and the right slot 322 respectively. Each pressing protrusion 2145, 2155 includes a pressing face (not labeled) facing downwardly and each insulative carrier has a receiving pressure face (not labeled)facing upwardly. The central shield 3 could press the first insulative carrier and the second insulative carrier respectively through the pressing protrusions 2145, 2155 and the slots 321, 322 for transferring the press force, when the modular jack is press-mounted to the horizontal PCB 200 along a top-to-bottom direction.

Referring to FIGS. 2-9, the insulative housing 1 defines two inner passageways or slots 141 at the two side walls 14 of the insulative housing 1. The inner passageways 141 are used for receiving the pressing protrusions 2145, 2155.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. A modular jack comprising:
an insulative housing defining a lower port, an upper port stacked on the lower port, and a mounting port located behind the lower and upper ports;
a lower printed circuit board (PCB) disposed horizontally in the mounting port, the lower PCB having a bottom face facing downwardly;
an upper PCB stacked on the lower PCB, the upper PCB having a top face facing upwardly;
a set of lower contacts each having a lower contacting portion extending backwardly and downwardly in the lower port and a connecting portion mounted on the bottom face;
a set of upper contacts each having an upper contacting portion extending backwardly and upwardly in the upper port and an upper connecting portion mounted on the top face; and
a terminal module located below the lower PCB, the terminal module having a set of first terminals electrically connected to the upper contacts through the upper PCB, a set of second terminals electrically connected to the lower contacts through the lower PCB, and a metal shielding plate disposed between the first terminals and the second terminals; wherein
the lower PCB has a first edge with a lower cutout recessed therefrom, said upper PCB has a second edge with an upper cutout recessed therefrom, and the metal shielding plate has a top inserting section inserted in the lower and upper cutouts and soldered simultaneously to the upper PCB and lower PCB.

2. The modular jack as claimed in claim 1, wherein said upper PCB has a grounding layer connected to the top inserting section of the metal shielding plate, and the upper cutout is a U-shaped notch viewed in a top-to-bottom direction.

3. The modular jack as claimed in claim 1, wherein said lower PCB has a grounding layer connected to the top inserting section of the metal shielding plate, and the lower cutout is a U-shaped notch viewed in a bottom-to-top direction.

4. The modular jack as claimed in claim 1, wherein said upper PCB has an upper tail protruding backwardly, the first edge located at a left side of the upper tail and the upper cutout recessed from the first edge along a left-to-right direction.

5. The modular jack as claimed in claim 4, wherein said lower PCB has a lower tail protruding backwardly, the second edge located at a right side of the lower tail and the lower cutout recessed from the second edge along a right-to-left direction.

6. The modular jack as claimed in claim 5, wherein the upper and lower tails are staggered in a top-to-bottom direction and at least partially overlapped in the top-to-bottom direction.

7. The modular jack as claimed in claim 1, wherein said terminal module includes a first insulative carrier holding the first terminals and a second insulative carrier holding the second terminals, the metal shielding plate sandwiched between the first and second insulative carriers.

8. The modular jack as claimed in claim 7, wherein the first insulative carrier has a first supporting face and a second supporting face located below the first supporting face, the second carrier having a third supporting face disposed at a same level with the second supporting face, the upper PCB supported by the first supporting face and the lower PCB, the lower PCB supported by the second and third supporting faces.

9. The modular jack as claimed in claim 7, wherein the first insulative carrier has a first rear protrusion protruding backwardly and supporting the lower tail, and the second carrier has a second rear protrusion protruding backwardly and supporting the upper tail.

10. The modular jack as claimed in claim 7, wherein first insulative carrier has a first post mounting into a through hole of the upper PCB and the second insulative carrier has a second post mounting into a through hole of the lower PCB.

11. An electrical connector comprising:
an insulative housing defining a front mating port and a rear connecting port along a front-to-back direction, said front mating port further divided into an upper mating port and a lower mating port;
stacked upper and lower printed circuit boards disposed in the housing, each of said upper and lower printed circuit boards extending in a horizontal plane defined by said front-to-back direction and a transverse direction perpendicular to said front-to-back direction;
a plurality of upper mating contacts mounted to the upper printed circuit board and extending into the upper mating port;
a plurality of lower mating contacts mounted to the lower printed circuit board and extending into the lower mating port;
first and second terminal modules disclosed under the lower printed circuit board and sandwiching commonly sandwiching a metallic shielding plate therebetween in the transverse direction, the first terminal module including first terminals having first upper sections connected to the upper printed circuit board and first lower sections connected to an external printed circuit board on which the housing is seated, the second terminal module including second upper sections connected to the lower printed circuit board and second lower sections connected to the external printed circuit board; wherein
the metallic shielding plate includes an upper section upwardly extending through both said upper and lower printed circuit boards electrically and mechanically in a soldered manner.

12. The electrical connector as claimed in claim 11, wherein said upper printed circuit board defines an upper notch and said lower printed circuit board defines a lower notch aligned with said upper notch in a vertical direction perpendicular to both said front-to-back direction and said transverse direction, and said upper section extends through both said lower notch and said upper notch in sequence.

13. The electrical connector as claimed in claim 12, wherein said upper notch is opened toward a first transverse direction while said lower notch is opened toward a second transverse direction opposite to said first transverse direction.

14. The electrical connector as claimed in claim 11, wherein said shielding plate forms mounting legs for mounted to the external printed circuit board between the first lower sections and the second lower sections in the transverse direction.

15. The electrical connector as claimed in claim 11, wherein said shielding plate includes a large cutout to receive a plurality of electronic components mounted upon an undersurface of the lower printed circuit board.

16. An electrical connector comprising:
an insulative housing defining a front mating port and a rear connecting port along a front-to-back direction, said front mating port further divided into an upper mating port and a lower mating port;
stacked upper and lower printed circuit boards disposed in the housing, each of said upper and lower printed circuit boards extending in a horizontal plane defined by said front-to-back direction and a transverse direction perpendicular to said front-to-back direction;
a plurality of upper mating contacts mounted to the upper printed circuit board and extending into the upper mating port;
a plurality of lower mating contacts mounted to the lower printed circuit board and extending into the lower mating port;
at least one terminal modules disclosed under the lower printed circuit board and including first terminals having upper sections connected to the printed circuit board and lower sections connected to an external printed circuit board on which the housing is seated; and
a metallic shielding plate located under the lower printed circuit board and beside said terminal module in the transverse direction; wherein
the metallic shielding plate includes an upper section upwardly extending through both said upper and lower printed circuit boards electrically and mechanically in a soldered manner.

17. The electrical connector as claimed in claim 16, wherein said upper printed circuit board defines an upper notch and said lower printed circuit board defines a lower notch aligned with said upper notch in a vertical direction perpendicular to both said front-to-back direction and said transverse direction, and said upper section extends through both said lower notch and said upper notch in sequence.

18. The electrical connector as claimed in claim 17, wherein said upper notch is opened toward a first transverse direction while said lower notch is opened toward a second transverse direction opposite to said first transverse direction.

19. The electrical connector as claimed in claim 16, wherein said shielding plate forms mounting legs for mounted to the external printed circuit board between the first lower sections and the second lower sections in the transverse direction.

20. The electrical connector as claimed in claim 16, wherein said shielding plate includes a large cutout to receive a plurality of electronic components mounted upon an undersurface of the lower printed circuit board.
